(19) United States
(12) Patent Application Publication
(10) Pub. No.: US 2015/0235279 A1
(43) Pub. Date: Aug. 20, 2015

(54) INFORMATION PROCESSING APPARATUS AND IMAGE DATA TRANSMITTING METHOD

(71) Applicant: Kabushiki Kaisha Toshiba, Tokyo (JP)

(72) Inventors: Shinichiro Imamura, Ome Tokyo (JP); Yuuichiro Aso, Hamura Tokyo (JP); Kenichi Taniuchi, Yokohama Kanagawa (JP)

(21) Appl. No.: 14/572,647

(22) Filed: Dec. 16, 2014

(30) Foreign Application Priority Data
Feb. 18, 2014 (JP) 2014-028412

(51) Int. Cl. G06Q 30/02

(52) U.S. Cl. CPC G06Q 30/0276; G06Q 30/0277

(57) ABSTRACT

According to one embodiment, an information processing apparatus generates content data including image data corresponding to products, and associates a sound effect identifier indicative of sound effect data in a memory region in a terminal with the image data in accordance with an operator's operation. The apparatus transmits to the terminal the image data together with the sound effect identifier associated with the image data in order to cause the terminal to play the image data and the sound effect data corresponding to the image data.

### CROSS-REFERENCE TO RELATED APPLICATIONS

This application is based upon and claims the benefit of priority from Japanese Patent Application No. 2014-028412, filed Feb. 18, 2014, the entire contents of which are incorporated herein by reference.

### FIELD

Embodiments described herein relate generally to technology for displaying an image.

### BACKGROUND

Recently, online shopping using electronic catalog data (digital catalog data) has been widespread.

A user can view images of products included in the electronic catalog data by downloading the electronic catalog data in a computing device such as a personal computer, a tablet computer and a smartphone.

In prior art, however, a list of the images of products included in the electronic catalog data is merely presented to the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary schematic diagram illustrating a system including an information processing apparatus (catalog distribution server) according to an embodiment.

FIG. 2 is an exemplary block diagram illustrating a system configuration of a client device receiving catalog digest data from the information processing apparatus of the embodiment.

FIG. 3 is an exemplary block diagram illustrating an example of a data structure of the catalog digest data generated by the information processing apparatus of the embodiment and a functional structure of a catalog browser executed by the client device of FIG. 2.

FIG. 4 is an exemplary illustration illustrating an appearance of a remote controller remote-controlling the client device of FIG. 2.

FIG. 5 is an exemplary block diagram illustrating a functional structure of the information processing apparatus of the embodiment.

FIG. 6A and FIG. 6B illustrate a service select screen and a catalog select screen which are displayed on TV by the client device of FIG. 2.

FIG. 7 is an exemplary view illustrating a catalog contents select screen displayed on TV by the client device of FIG. 2.

FIG. 8A, FIG. 8B and FIG. 8C illustrate a transition of images on a catalog digest screen displayed on TV by the client device of FIG. 2.

FIG. 9A and FIG. 9B illustrate a product detail screen and an order confirmation screen displayed on TV by the client device of FIG. 2.

FIG. 10 is an exemplary view illustrating a catalog digest data generating operation executed by the information processing apparatus of the embodiment.

FIG. 11 is an exemplary view illustrating electronic catalog data (original data) used at the information processing apparatus of the embodiment.

FIG. 12 is an exemplary view illustrating spread data generated by the information processing apparatus of the embodiment.

FIG. 13 is an exemplary view illustrating an operation of selecting image data to be embedded in the catalog digest data.

FIG. 14 is an exemplary view illustrating an edit screen displayed on a display of an operation terminal.

FIG. 15 is an exemplary view illustrating effect sets each including a combination of sound effect and image effect.

FIG. 16 is an exemplary flowchart illustrating procedure of catalog digest data generation process executed by the information processing apparatus of the embodiment.

FIG. 17 is an exemplary illustration for explanation of catalog digest data transmission executed by the information processing apparatus of the embodiment.

FIG. 18 is an exemplary flowchart illustrating procedure of catalog digest data playing process executed by the client device of FIG. 2.

FIG. 19 is an exemplary block diagram illustrating a television system configuration including a function of the client device of FIG. 2.

### DETAILED DESCRIPTION

Various embodiments will be described hereinafter with reference to the accompanying drawings.

In general, according to one embodiment, an information processing apparatus comprises a processor and a transmitter. The processor generates content data including image data corresponding to products, and associates a sound effect identifier indicative of sound effect data stored in a memory region in a terminal with the image data in accordance with an operator's operation. The transmitter transmits to the terminal the image data together with the sound effect identifier associated with the image data in order to cause the terminal to play each of the image data and the sound effect data corresponding to the image data.

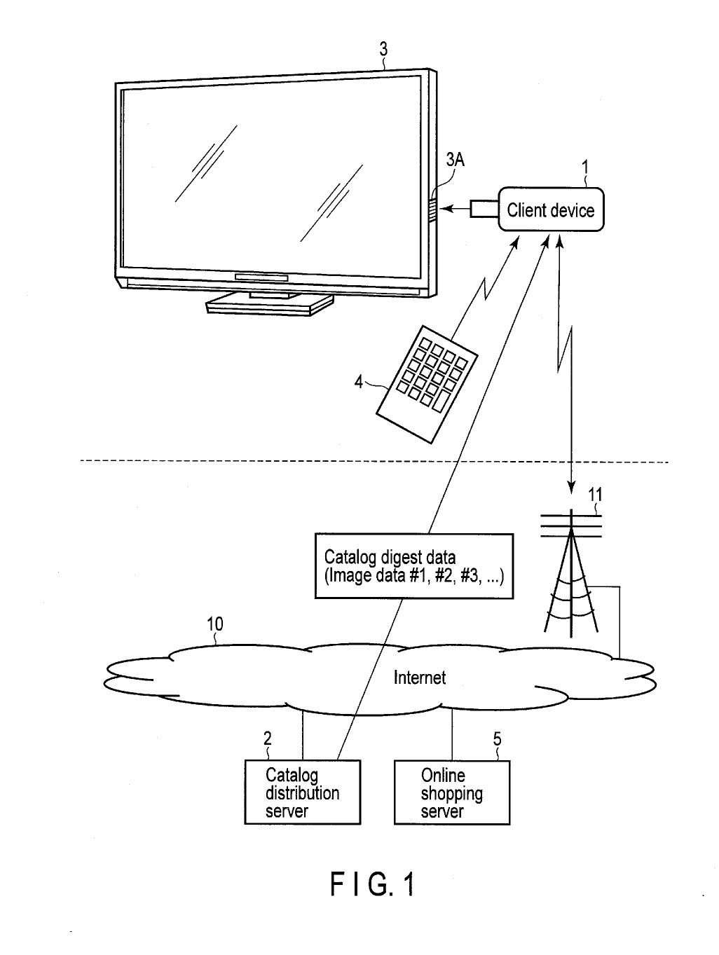

First, a system including the information processing apparatus of the embodiment will be described with reference to FIG. 1. The embodiment is implemented as a catalog distribution server 2 configured to transmit a plurality of image data items (catalog digest data items) corresponding to a plurality of preselected products to one or more terminals. The above-described terminal example is not limited, but it is assumed that a client device 1 or a set of the client device 1 and a television receiver 3 functions as the above-described terminal.

The client device 1 is a device configured to sequentially display the plurality of image data items included in the catalog digest data received from the catalog distribution server 2 on a display (television receiver 3). The client device 1 may be an HDMI® dongle, which is a device connected to HDMI® input terminals of various devices so as to be detachable therefrom. If the client device 1 is implemented as the HDMI® dongle, the client device 1 may be connected to an HDMI® input terminal 3A of the television receiver 3. The television receiver 3 to which the client device 1 is connected can display the catalog digest data.

The client device 1 has a wireless network communication function such as 3G mobile communication and can communicate with the catalog distribution server 2 via a base station 11 and Internet 10. The client device 1 is further configured to execute an operation corresponding to remote control information (operation signal) received from a remote controller 4.

In response to reception of the remote control information to request display of the catalog digest data from the remote controller 4, the client device 1 requests the catalog distribution server 2 to transmit the catalog digest data.

The catalog digest data may be, for example, a digest of electronic catalog data (online catalog data) including images of a number of products handled by an online shopping company.

In this case, image data corresponding to each of products included in the catalog digest data may be extracted from the electronic catalog data. The catalog distribution server 2 may resize each of the image data items extracted from the electronic catalog data and convert each of the image data items to image data having a resolution suitable for the screen of the television receiver 3. The catalog distribution server 2 may further subject each of the image data items to an image quality enhancement process (image quality improvement enhancement process) to improve image quality.

The client device 1 sequentially plays a plurality of image data items in the catalog digest data while downloading the plurality of image data items in the catalog digest data from the catalog distribution server 2. In this case, the image data items to be played (displayed) are sequentially changed in the plurality of image data items included in the catalog digest data. For example, if a first image data item is displayed for a certain period (for example, approximately ten seconds), the image data item to be displayed is automatically changed to a next image data item. Downloading the image data item from the catalog distribution server 2 may be completed during the display of the first image data item.

The user can sequentially view the plurality of product images included in the catalog digest data without executing any operations to change the image data item to be displayed. Furthermore, the user can instruct the client device 1 to purchase a desired product by an operation using the remote controller 4. A product number of the product which the user decides to purchase may be transmitted from the client device 1 to an online shopping server 5 via the catalog distribution server 2. The online shopping server 5 is a server of an online shopping company, and can execute various types of processing for online shopping.

The catalog distribution server 2 may transmit not only the catalog digest data, but also original electronic catalog data (original catalog data) from which each of the image data items is extracted, of the catalog digest data, to the client device 1. The user can request a desired type of catalog data (catalog digest data or original catalog data) to the catalog distribution server 2 by operating the remote controller 4.

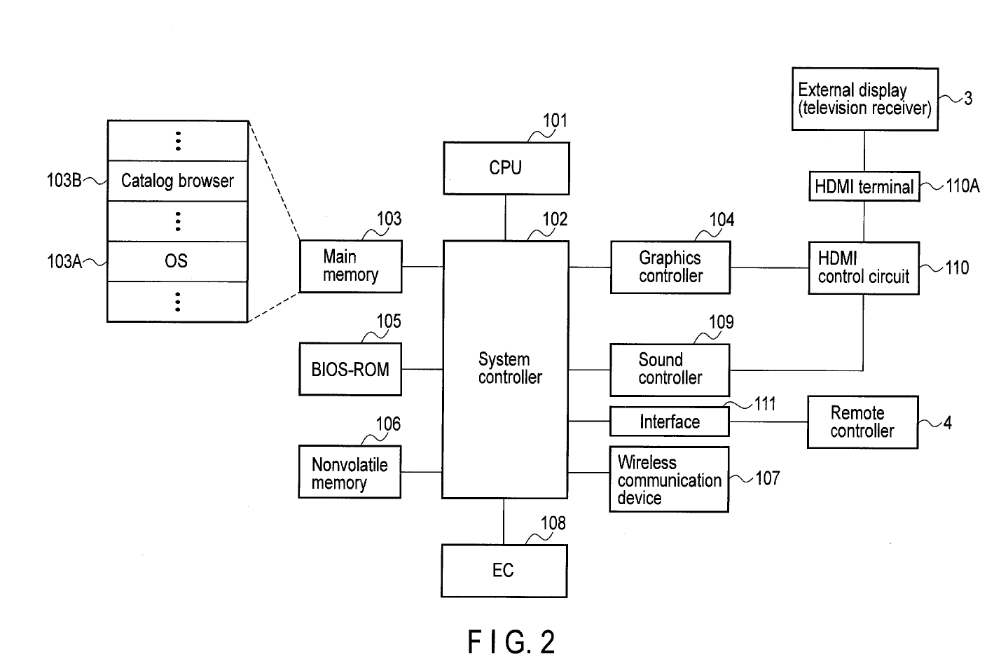

FIG. 2 illustrates an example of a system configuration of the client device 1.

The client device 1 comprises a CPU 101, a system controller 102, a main memory 103, a graphics controller 104, a BIOS-ROM 105, a nonvolatile memory 106, a wireless communication device 107, an embedded controller (EC) 108, a sound controller 109, an HDMI control circuit 110, an interface 111, etc. as shown in FIG. 2.

The CPU 101 is a processor which controls operations of various components in the client device 1. The CPU 101 executes various programs loaded on the main memory 103 from the nonvolatile memory 106 serving as a storage device. The programs include an operating system (OS) 103A and various application programs. The application programs include a catalog browser 103B. The catalog browser 103B has a display control function of controlling display of the image data included in the catalog digest data, etc.

In addition, the CPU 101 also executes Basic Input Output System (BIOS) stored in the BIOS-ROM 105. The BIOS is a program for hardware control.

The system controller 102 is a device which connects a local bus of the CPU 101 with various components. A memory controller which controls access to the main memory 103 is built in the system controller 102. The system controller 102 also has a function of executing communication with the graphics controller 104 via a serial bus conforming to the PCI EXPRESS standard, etc.

The graphics controller 104 transmits a digital video signal to an external display (for example, television receiver 3) via the HDMI control circuit 110 and an HDMI terminal 110A. The sound controller 109 transmits a digital audio signal to the external display via the HDMI control circuit 110 and an HDMI terminal 110A. The HDMI terminal 110A can transmit an uncompressed digital video signal and a digital audio signal to the external display such as the television receiver 3 by means of a cable. The HDMI control circuit 110 is an interface which transmits the digital video signal and a digital audio signal to an external video device via the HDMI terminal 110A.

The wireless communication device 107 is a device which executes wireless communication such as 3G mobile communication.

The interface 111 functions as a receiver which receives a signal from an external electronic device (for example, remote controller 4). The interface 111 may be an infrared receiver, or a transceiver which executes wireless communication conforming to Bluetooth® standard.

In the nonvolatile memory 106, a plurality of sound effect data items and a plurality of effect image data items are stored besides the above-described programs. The sound effect data items and the effect image data items are used as additional information that presents each product to the user by giving sizzling feeling to each product image in the catalog digest data. Additional contents (sound effect data and effect image data) to be applied to individual item of the image data are determined based on an identifier added to each of the image data items in the catalog digest data. The sound effect data is played by the client device 1 and a sound corresponding to the sound effect data is output from a speaker of the television receiver 3. The effect image data is overlaid (superimposed) on image data of a corresponding product by the client device 1 to produce a composite image. The composite image, i.e., image of the product on which effect image data is overlaid is displayed on the display of the television receiver 3.

The type of the sound effect data and the effect image data pre-stored in the nonvolatile memory 106 is not limited but, for example, a plurality of sound effect data items suitable to several types of foods and a plurality of effect image data items suitable to the several types of foods may be pre-stored in the nonvolatile memory 106.

The plurality of sound effect data items may be a plurality of sound data items for playing plural types of cooking sounds. The cooking sounds indicate sounds generated at cooking (preparing) foods. For example, for pot-cooking, “simmering” sound effect data may be prepared. For cooking using meat, etc., “sizzling” sound effect data may be prepared. For beverage, “sparkling” sound effect data, sound effect data indicating a sound generated at pouring the beverage into a glass, etc. may be prepared.

The plurality of effect image data items are, for example, effect image data indicating steam or smoke, effect image data indicating a droplet, effect image data indicating water spray, etc.

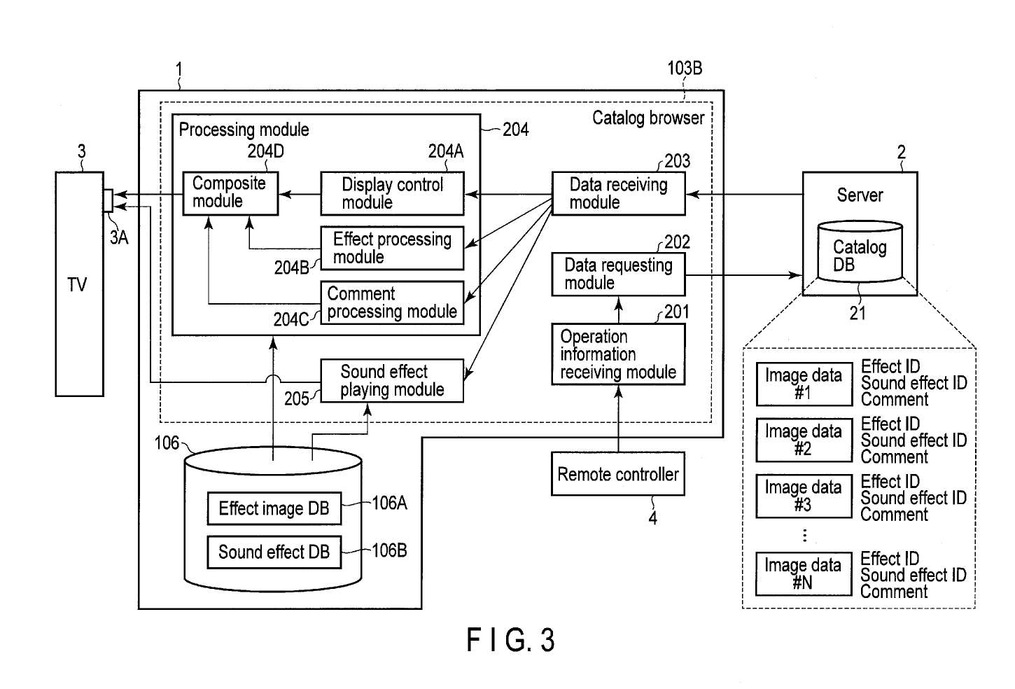

Next, an example of a data structure of the catalog digest data and an example of a functional structure of the catalog browser 103B will be described with reference to FIG. 3B.

The catalog digest data generated by the catalog distribution server 2 is stored in a catalog database 21 of the catalog distribution server 2. The catalog digest data includes a plurality of image data items (image data #1, image data #2, image data #3, . . . , image data #N) corresponding to a plurality of products.

Each of image data items (each of product images) may be a photograph of the product or may include the photograph of the product and explanations concerning the product (for example, product name, price, advertisement message, etc.). These image data items can be obtained by extracting the images of products from the original catalog data as described above.

In the catalog digest data, an effect ID, a sound effect ID, and a comment are preliminarily associated with each of image data items.

The effect ID is an effect image identifier indicating one of a plurality of effect images that can be generated by the client device 1. In other words, the effect ID indicates one of the plurality of effect image data items stored in an effect image database 106A of the client device 1. The effect image database 106A is a memory region in the nonvolatile memory 106. The effect image data indicated by the effect ID is used as effect image data to be displayed over image data (product image) associated with the effect ID.

The sound effect ID is a sound effect identifier indicating one of sound effects that can be played by the client device 1. In other words, the sound effect ID indicates one of a plurality of sound effect data items stored in a sound effect database 106B of the client device 1. The sound effect database 106B is a memory region in the nonvolatile memory 106. The sound effect data indicated by the sound effect ID is used as sound effect data to be generated while image data (product image) associated with the sound effect ID is displayed.

The comment is an additional message (text) to be displayed together with image data (product image) associated with the comment.

The catalog distribution server 2 transmits to the client device 1 each of image data #1, image data #2, image data #3, . . . , image data #N together with the effect ID, the sound effect ID, and the comment associated with the image data. In other words, the plurality of image data items each including the effect ID, the sound effect ID, and the comment are sequentially transmitted to the client device 1.

The catalog browser 103B of the client device 1 comprises an operation information receiving module 201, a data requesting module 202, a data receiving module 203, a processing module 204, a sound effect playing module 205, etc.

First, the operation information receiving module 201 receives operation information (remote-control information) from the remote controller 4 and outputs the operation information to the data requesting module 202. The data requesting module 202 requests data necessary for screen display corresponding to operation information from the catalog distribution server 2. The data receiving module 203 receives data from the catalog distribution server 2.

The processing module 204 executes processing for displaying the original catalog data received from the catalog distribution server 2 or processing for displaying the catalog digest data received from the catalog distribution server 2. Processing for displaying the image data #1 in the catalog digest data will be hereinafter described.

The image data #1 received by the data receiving module 203 is transmitted to a display control module 204A. The display control module 204A generates an image signal corresponding to the image data #1 and transmits the generated image signal to a composite module 204D. The effect ID added to the image data #1 is transmitted from the data receiving module 203 to the effect processing module 204B. The effect processing module 204B reads effect image data designated by the effect ID from the effect image database 106A. The effect processing module 204B transmits an image signal corresponding to the read effect image data to the composite module 204D. The comment added to the image data #1 is transmitted from the data receiving module 203 to a comment processing module 204C. The comment processing module 204C transmits an image signal corresponding to the comment to the composite module 204D.

The composite module 204D composites the image corresponding to the image data #1, the image corresponding to the effect image data and the comment (text), and thereby generates a screen image to be displayed. In the screen image, the comment is displayed in a region which does not overlap the display region of the image corresponding to the image data #1.

In contrast, the image corresponding to the effect image data is overlaid on the image corresponding to the image data #1. In other words, the image corresponding to the effect image data is displayed in a region which overlaps a region where the image corresponding to the image data #1 is displayed. The effect ID may include position information designating a display position of the effect image data. In this case, the composite module 204D overlays the image of the effect image data on the image of the image data #1 such that the image of the effect image data is displayed at the display position on the image of the image data #1. A video signal corresponding to the screen image generated by the composite module 204D is transmitted to the television receiver 3.

The sound effect ID added to the image data #1 is transmitted from the data receiving module 203 to the sound effect playing module 205. The sound effect playing module 205 reads sound effect data designated by the sound effect ID from the sound effect database 106B. Then, the sound effect playing module 205 generates an audio signal corresponding to the read sound effect data. The audio signal is transmitted to the television receiver 3.

Thus, in the present embodiment, the sound effect data and the effect image data are not transmitted from the catalog distribution server 2 to the client device 1, but the sound effect ID and the effect ID are transmitted from the catalog distribution server 2 to the client device 1. The plurality of sound effect data items and the plurality of effect image data items are prepared in the client device 1, and the sound effect data and the effect image data designated by the sound effect ID and the effect ID are played by the client device 1. Each product image and the additional information can be therefore presented to the user without increasing the amount of data to be transmitted from the catalog distribution server 2 to the client device 1.

In the above descriptions, the effect ID, the sound effect ID and the comment are associated with each of image data items in the catalog digest data, but, the sound effect ID alone may be associated with each of image data items in the catalog digest data.

In addition, each image data item may be integrated into data (HTML data) described in a markup language such as HTML. In this case, the HTML data may include the effect ID, the sound effect ID and the comment besides the image data.

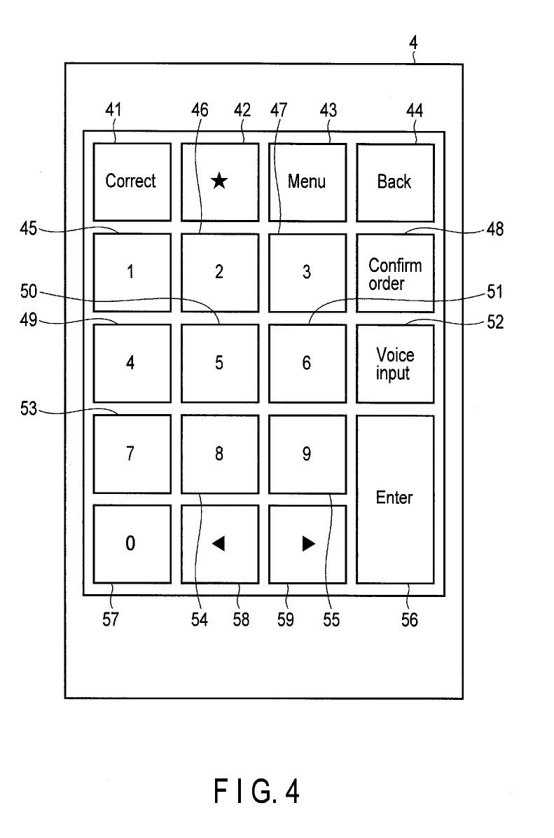

FIG. 4 illustrates a remote control button group of the remote controller 4.

The remote controller 4 comprises remote control buttons 41 to 59 as shown in FIG. 4. The buttons 41 to 59 include “Correct” button 41, “Star” button 42, a “Menu” button 43, “Back” button 44, number buttons 45-47 corresponding to number 1 to number 3, “Confirm order” button 48, number buttons 49-51 corresponding to number 4 to number 6, “Voice input” button 52, number buttons 53-55 corresponding to number 7 to number 9, “Enter” button 56, number button 57 corresponding to zero, “Left arrow” button 58 and “Right arrow” button 59.

The “Correct” button 41 is a button for instructing correction of an input number, etc. The “Star” button 42 is a button for instructing display of a bookmark, etc. The “Menu” button 43 is a button for instructing display of a menu screen. The “Confirm order” button 48 is a button for instructing display of a list of ordered products. The “Voice input” button 52 is a button for instructing shift to a voice input mode.

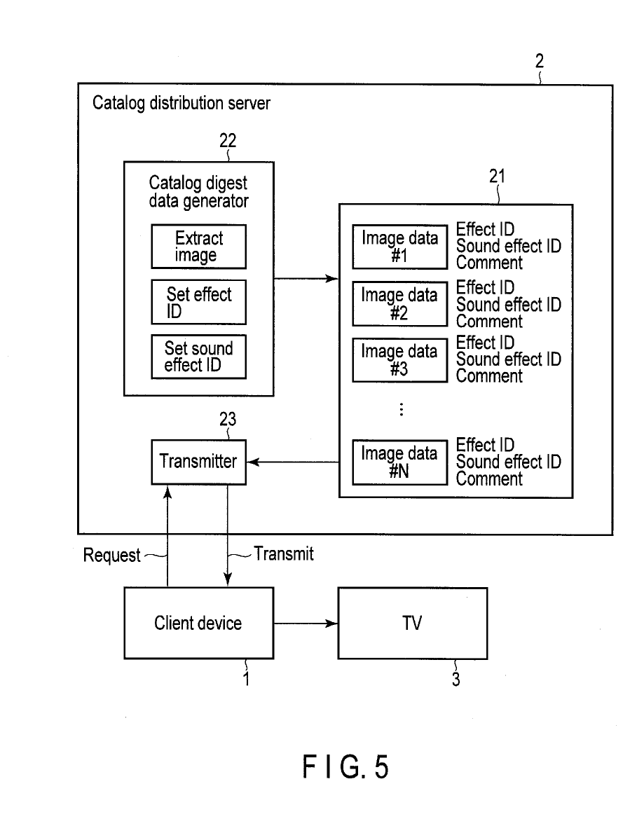

FIG. 5 illustrates a functional configuration of the catalog distribution server 2.

The catalog distribution server 2 comprises a catalog digest data generator 22 and a transmitter 23 besides the catalog database 21.

The catalog digest data generator 22 is realized by a processor in a catalog distribution server 2. The catalog digest data generator 22 generates the catalog digest data, i.e., content data including a plurality of image data items corresponding to a plurality of products. Furthermore, the catalog digest data generator 22 executes processing of associating the sound effect ID and the effect ID with each of the plurality of image data items, based on an operator's operation.

In other words, the catalog digest data generator 22 comprises an image extracting function, an effect ID setting function, and a sound effect ID setting function. The image extracting function is a function of extracting (cutting) images associated with some products from the original catalog data. The effect ID setting function and the sound effect ID setting function are functions of associating the effect ID and the sound effect ID with each of the extracted image data items.

The transmitter 23 transmits each of the plurality of image data items in the catalog digest data together with the effect ID, the sound effect ID and the comment associated with each of the image data items, to the client device 1, in order to cause the client device 1 to play (reproduce) each of the plurality of image data items and additional data (effect image data, sound effect data and comment) corresponding to each of the plurality of image data items.

In other words, when a first image data request is received from the client device 1, the transmitter 23 transmits the image data #1 in the catalog digest data together with the effect ID, the sound effect ID and the comment associated with the image data #1, to the client device 1. The client device 1 is thereby instructed to play (reproduce) the image data #1, the effect image data corresponding to the effect ID, the sound effect data corresponding to the sound effect ID, and the comment.

When a next image data request is received from the client device 1, the transmitter 23 transmits the image data #2 in the catalog digest data together with the effect ID, the sound effect ID and the comment associated with the image data #2, to the client device 1. The client device 1 is thereby instructed to play (reproduce) the image data #2, the effect image data corresponding to the effect ID, the sound effect data corresponding to the sound effect ID, and the comment.

The function of the catalog digest data generator 22 and the function for controlling the transmitter 23 may be implemented by the computer program executed by the CPU (processor) in the catalog distribution server 2.

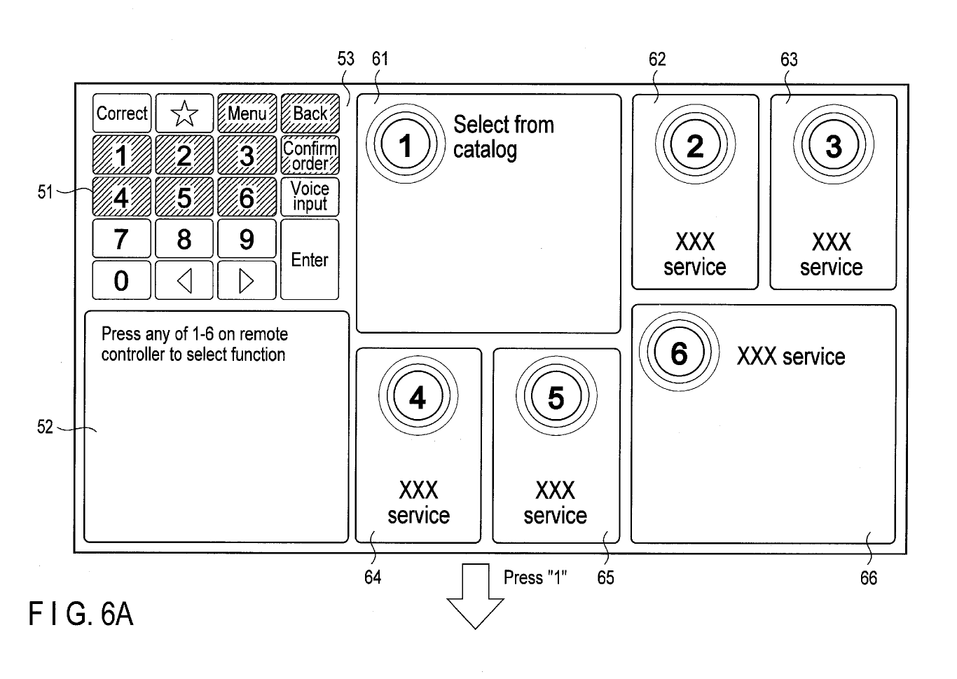

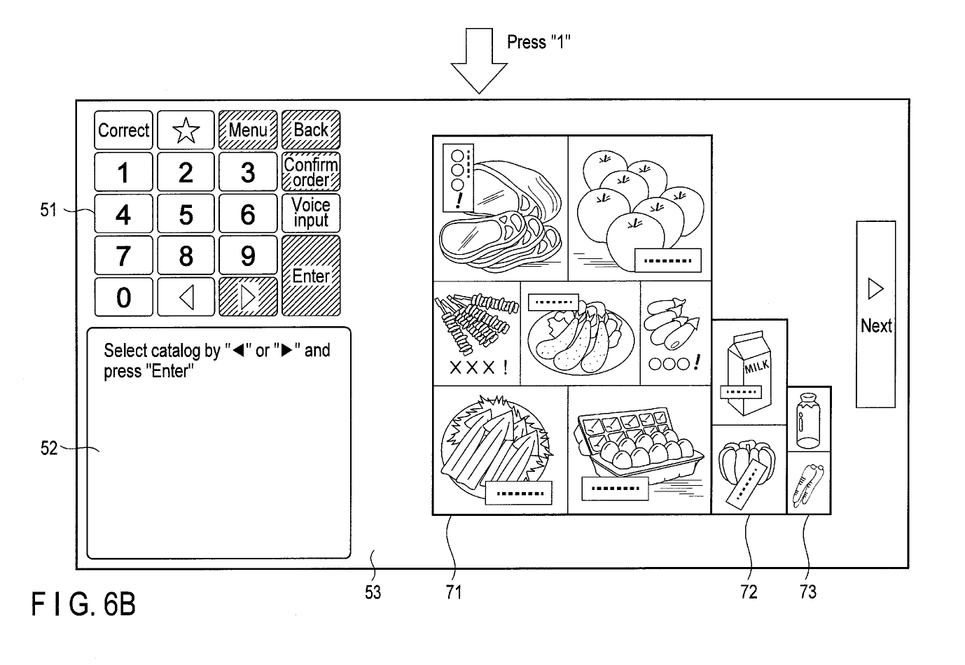

FIG. 6A and FIG. 6B illustrate a service select screen and a catalog select screen displayed on the television receiver 3 by the client device 1.

On a background 53 of the service select screen of FIG. 6A, a remote control button guide 51, an operation guide message 52 and service select items 61-66 are displayed. To the service select items 61-66, “1” button to “6” button of the remote controller 4 are assigned. The service select item 61 is an item for instructing execution of service for viewing a catalog (i.e., service for online shopping using a catalog). The service select items 62-66 are items for instructing execution of the other services.

The remote control button guide 51 displays a plurality of buttons (software buttons) corresponding to a plurality of remote control buttons of the remote controller 4 shown in FIG. 4, respectively. In the remote control button guide 51, the plurality of buttons are arranged in the same layout as a layout of the plurality of buttons of the remote controller 4. Furthermore, in the remote control button guide 51, an available button is displayed in a specific color (for example, orange) while an unavailable button is displayed in a different specific color (for example, black). The user can be thereby guided in the operations of the remote controller 4 necessary to view the catalog such as the catalog digest data such that the user can easily understand the operations. In FIG. 6A, an orange button (available remote control button) is shown by hutching.

The operation guide message 52 is a text for presenting an operation method corresponding to the currently displayed screen to the user.

A screen image of the service select screen may be presented to the client device 1 by the catalog distribution server 2.

When the “1” button of the remote controller 4 is pressed by the user, the client device 1 displays a catalog select screen of FIG. 6B. The screen image of the catalog select screen may also be provided to the client device 1 by the catalog distribution server 2.

On the background 53 of the catalog select screen, the button guide 51, the operation guide message 52, and catalog thumbnails 71-73 corresponding to respective viewable catalogs are displayed. The user can select a desired catalog thumbnail by pressing the “left arrow” button 58 or the “right arrow” button 59 of the remote controller 4. The selected catalog thumbnail is displayed in a size larger than a size of the other catalog thumbnails.

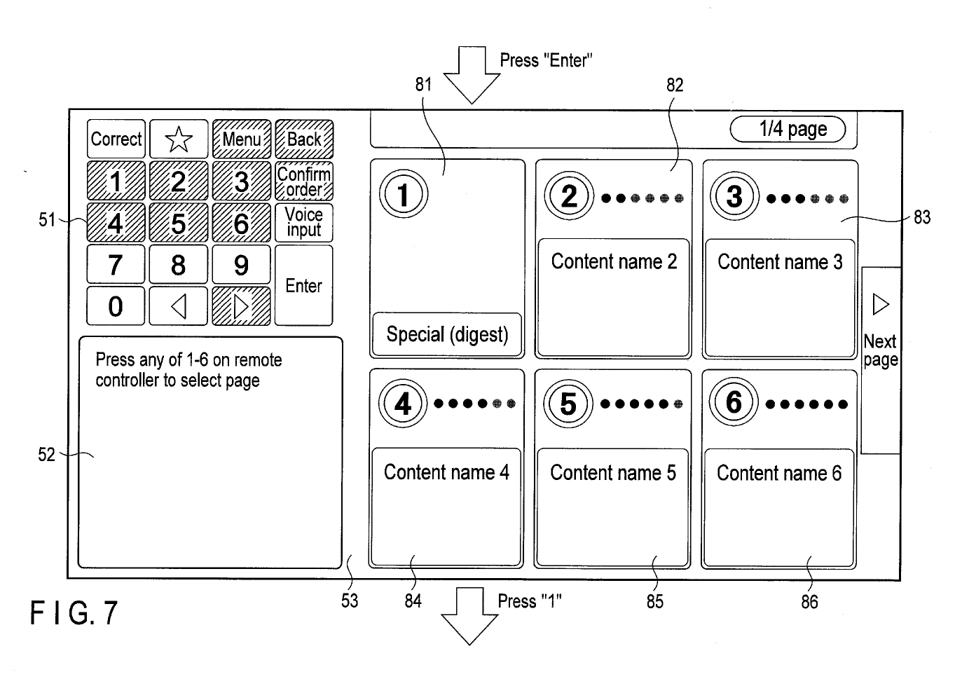

When the “Enter” button 56 of the remote controller 4 is pressed in a situation in which a certain catalog thumbnail is selected, the client device 1 selects the catalog corresponding to the selected catalog thumbnail. The client device 1 displays a catalog contents select screen corresponding to the selected catalog as shown in FIG. 7. The screen image of the catalog contents select screen may also be provided to the client device 1 by the catalog distribution server 2.

On the background 53 of the catalog select screen, the button guide 51, the operation guide message 52, an item 81 for viewing a digest of the selected catalog, and items 82-86 for jumping to some headline pages in the selected catalog are displayed.

When the “1” button 45 of the remote controller 4 corresponding to the item 81 is pressed, the client device 1 requests the catalog distribution server 2 to transmit first image data in the catalog digest data corresponding to the selected catalog. Then, the client device 1 starts display of the catalog digest screen.

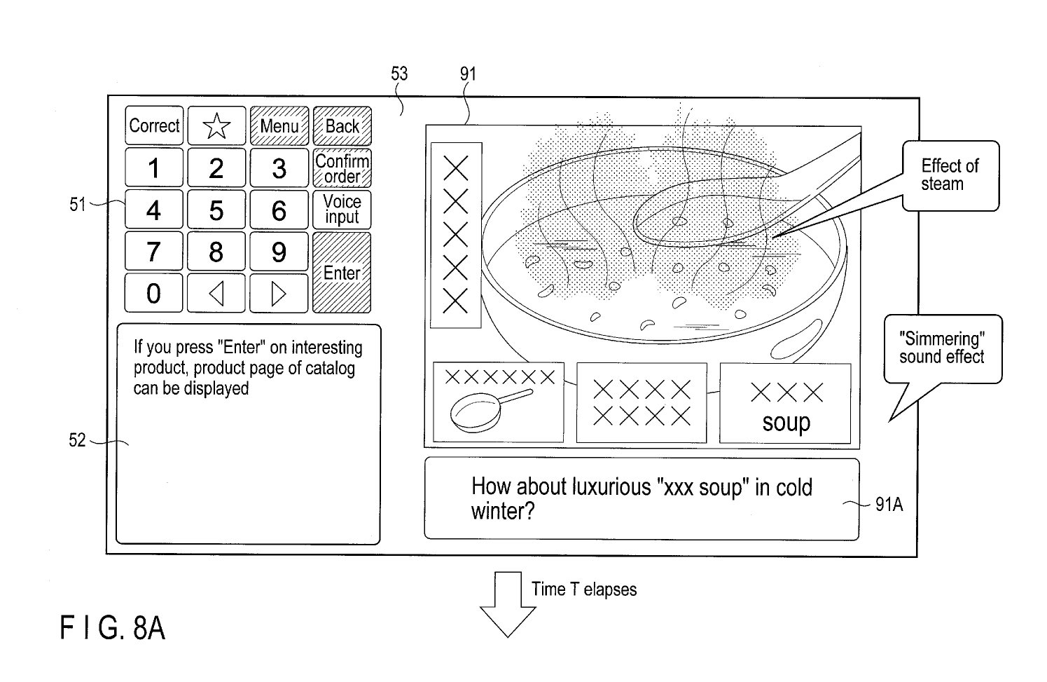

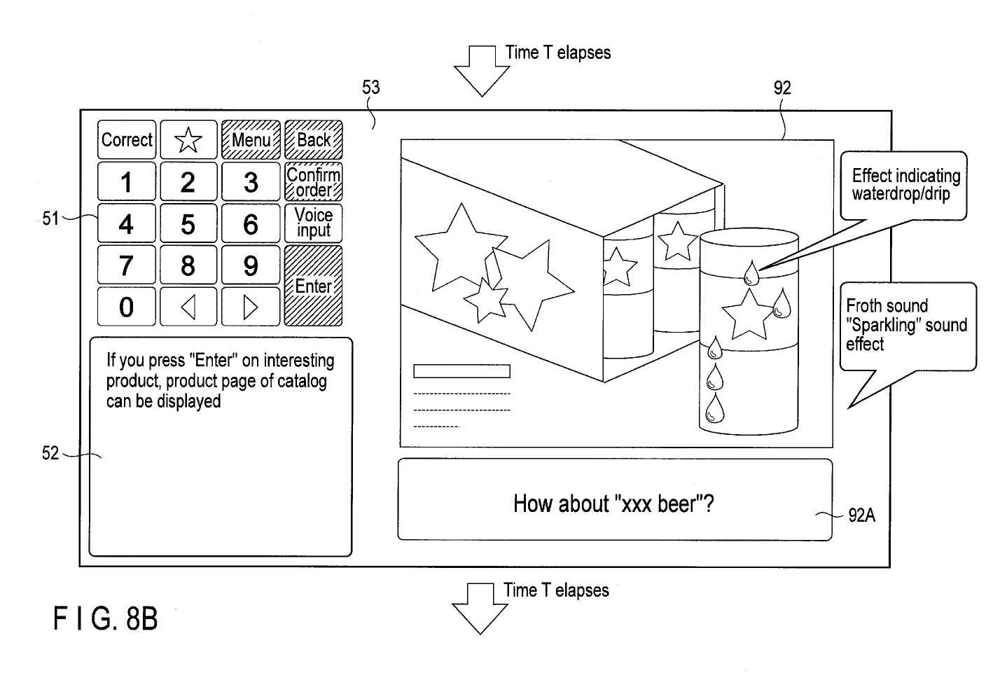

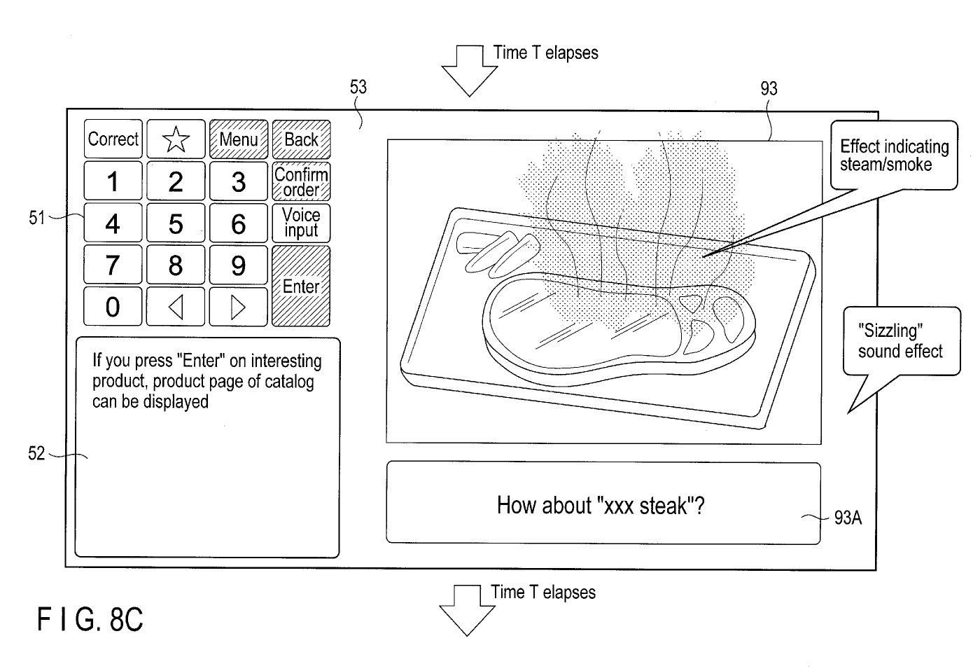

FIG. 8A, FIG. 8B and FIG. 8C illustrate a transition of images on the catalog digest screen. It is assumed that the catalog digest data includes the image data #1, the image data #2, and the image data #3.

FIG. 8A illustrates the catalog digest screen for displaying an image corresponding to the image data #1. On the background 53 of the catalog digest screen, the button guide 51, the operation guide message 52, the image 91 corresponding to the image data #1, and a comment 91A corresponding to the image data #1 are displayed. The comment 91A is a comment associated with the image data #1.

On the image 91, an effect image is displayed. The effect image can be obtained by playing (reproducing) the effect image data corresponding to the effect ID associated with the image data #1. It is assumed that the image data #1 is an image of pot-cooking (for example, soup) food and that the effect ID indicating the effect image data presenting steam is associated with the image data #1.

In the client device 1, the effect image data corresponding to the effect ID is read from the effect image database 106A. An image corresponding to the effect image data is overlaid on the image corresponding to the image data #1 to produce the composite image in which the images are combined, and the composite image is displayed on the catalog digest screen. The effect image data may be a still image or a moving image.

The effect image data is thus played at the client device 1. For this reason, a region where the effect image presenting steam can be displayed is not limited to a region on the image data #1. For example, the effect image presenting steam may be displayed on a region overlapping both a region corresponding to the image data #1 and a region corresponding to the background 53.

The image 91 corresponding to the image data #1 is continuously displayed for, for example, approximately ten seconds. A sound effect continues being played while the image 91 is displayed. The sound effect is designated by the sound effect ID associated with the image data #1. For example, a “simmering” sound, i.e., sound of pot-cooking (for example, soup) is played as the sound effect. In other words, the sound effect data corresponding to the sound effect ID is read from the sound effect database 106B, at the client device 1. Then, the sound effect corresponding to the sound effect data is automatically played.

A certain music, etc. may be further played besides the sound effect. Moreover, a voice message explaining the product corresponding to the image data #1 may be played.

The music data to be played may be prestored in the client device 1, similarly to the sound effect data. In this case, the catalog distribution server 2 may transmit an ID indicating the music data as a part of the additional data associated with the image data #1, to the client device 1.

The entire screen image in FIG. 8A except the effect image and the comment 91A may be provided to the client device 1 by the catalog distribution server 2.

When the image 91 corresponding to the image data #1 is displayed for approximately ten seconds, the image of the product to be displayed on the catalog digest screen is automatically changed from the image corresponding to the image data #1 to an image corresponding to the image data #2 as shown in FIG. 8B.

On the catalog digest screen of FIG. 8B, an image 92 and a comment 92A corresponding to the image data #2 are displayed. The comment 92A is a comment associated with the image data #2. On the image 92, an effect image is displayed. The effect image can be obtained by playing the effect image data corresponding to the effect ID associated with the image data #2. It is assumed that the image data #2 is an image of beverage (beer) food and that the effect ID indicating the effect image data presenting water drop is associated with the image data #2. The effect image data may be a still image or a moving image. The effect ID may include position information designating a display position of the effect image presenting water drop. The effect image presenting water drop can be thereby displayed on the image of beer.

The image 92 corresponding to the image data #2 is continuously displayed for, for example, approximately ten seconds. The sound effect continues being played while the image 92 is displayed. The sound effect is designated by the sound effect ID associated with the image data #2. For example, a “sparkling” sound is played as the sound effect.

When the image 92 corresponding to the image data #2 is displayed for approximately ten seconds, the image of the product to be displayed on the catalog digest screen is automatically changed from the image corresponding to the image data #2 to an image corresponding to the image data #3 as shown in FIG. 8C.

On the catalog digest screen of FIG. 8C, an image 93 and a comment 93A corresponding to the image data #3 are displayed. The comment 93A is a comment associated with the image data #3. On the image 93, an effect image is displayed. The effect image can be obtained by playing the effect image data corresponding to the effect ID associated with the image data #3. It is assumed that the image data #3 is an image of food of meat dish (for example, steak) and that the effect ID indicating the effect image data presenting steam or smoke is associated with the image data #3. The effect image data may be a still image or a moving image. The image 93 corresponding to the image data #3 is continuously displayed for, for example, approximately ten seconds. The sound effect continues being played while the image 93 is displayed. The sound effect is designated by the sound effect ID associated with the image data #3. For example, a “sizzling” sound, which is a cooking sound of meat dish (for example, steak) is played as the sound effect.

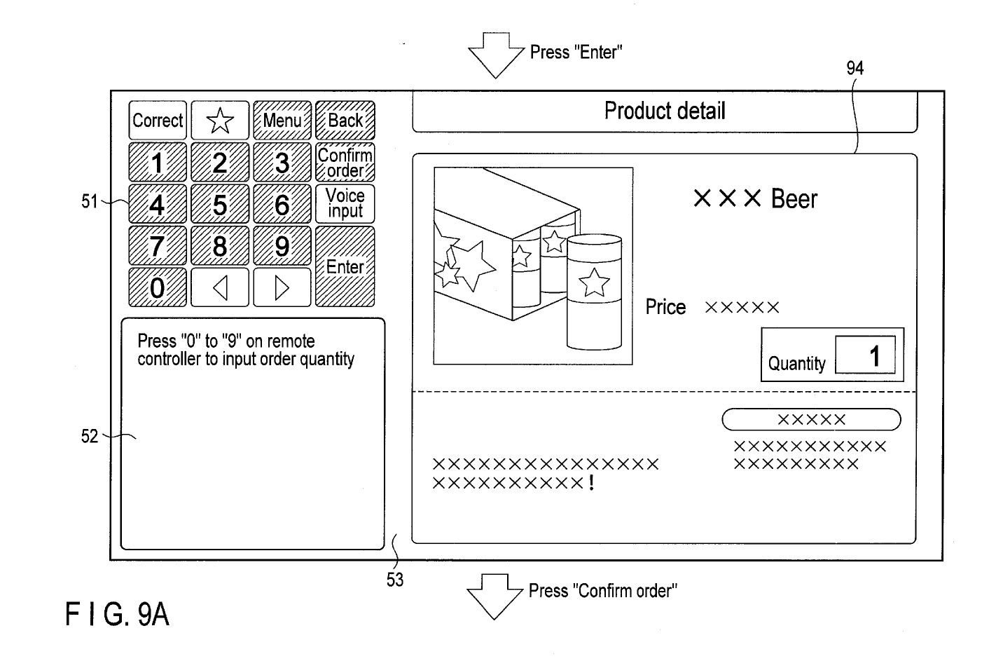

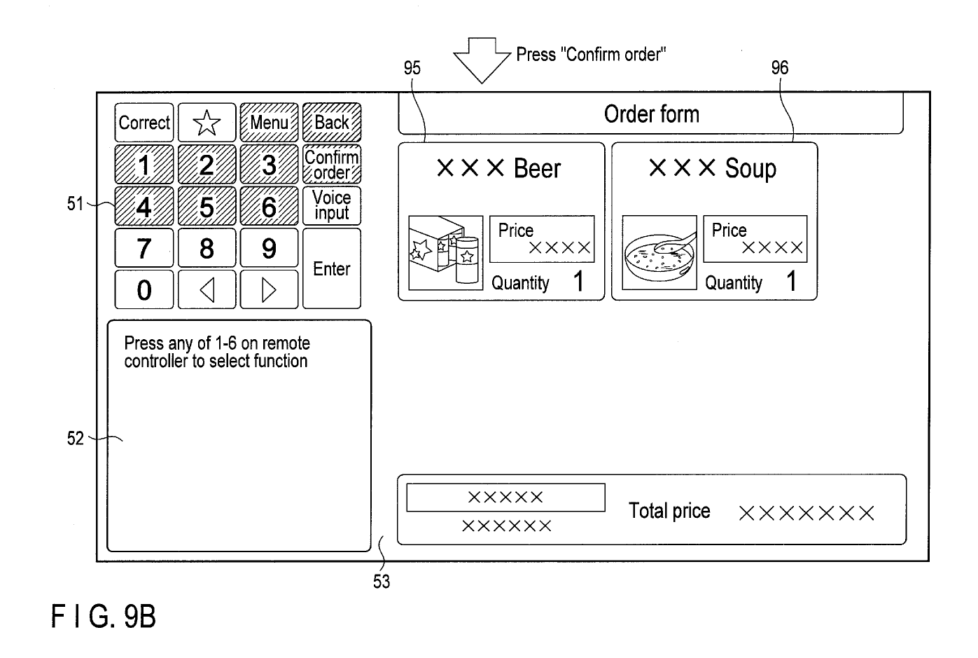

FIG. 9A and FIG. 9B illustrate a product detail screen and an order confirmation screen displayed by the client device 1.

FIG. 9A illustrates the product detail screen. When the “Enter” button 56 of the remote controller 4 is pressed in a situation in which an image 92 shown in FIG. 8B is displayed, product detail information 94 for purchase (order) of products (beer) corresponding to the image data #2 is displayed as shown in the FIG. 9A. In other words, a product number corresponding to the image data #2 is transmitted from the client device 1 to the catalog distribution server 2, and the product detail information is transmitted from the catalog distribution server 2 to the client device 1. Of course, the entire screen image shown in FIG. 9A may be transmitted from the catalog distribution server 2 to the client device 1. The user can input an order quantity by pressing any number button of the remote controller 4. When the order quantity is input, the client device 1 transmits the product number corresponding to the image data #2 and the order quantity to the catalog distribution server 2. The catalog distribution server 2 transmits the product number corresponding to the image data #2 and the order quantity to the online shopping server 5.

When the “Confirm order” button 48 of the remote controller 4 is pressed, the order confirmation screen (order form screen) is displayed as shown in FIG. 9B. A price and the order quantity of each product ordered are displayed on the order confirmation screen. For example, if the product corresponding to the image data #1 and the product corresponding to the image data #2 are ordered, order information 95 indicating the price and the order quantity of the product corresponding to the image data #1 and order information 96 indicating the price and the order quantity of the product corresponding to the image data #2 are displayed. Furthermore, a total price is also displayed on the order confirmation screen.

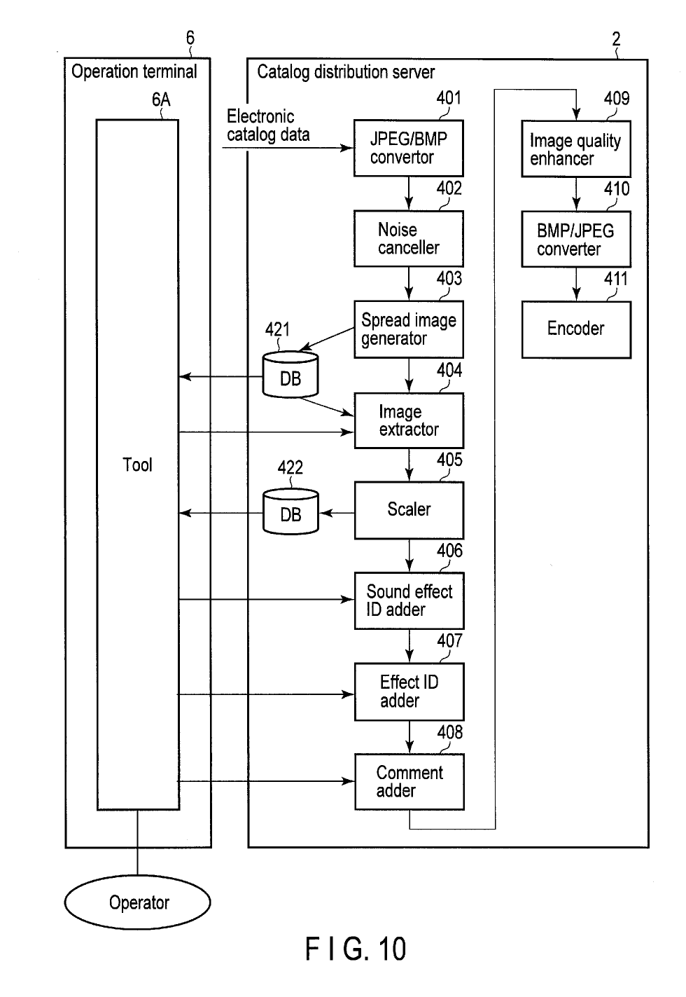

FIG. 10 illustrates a catalog digest data generating operation executed by the catalog distribution server 2.

The catalog distribution server 2 comprises a JPEG/BMP conversion processor 401, a noise canceller 402, a spread image generator 403, an image extractor 404, a scaler 405, a sound effect ID adder 406, an effect adder 407, a comment adder 408, an image quality enhancer 409, a BMP/JPEG converter 410, and an encoder 411. These are employed to generate the catalog digest data. In the processing of generating the catalog digest data, an operation of selecting the image data to be extracted from the electronic catalog data (original catalog data) and an operation of selecting the sound effect/image effect to be associated with each of the image data items are executed by the operator. The operator can execute the operations by using a tool 6A executed on an operation terminal 6. The tool 6A is a computer program having a function in connection with the catalog distribution server 2. The operation terminal 6 may be a terminal connected to the catalog distribution server 2 or a terminal connected to the online shopping server 5.

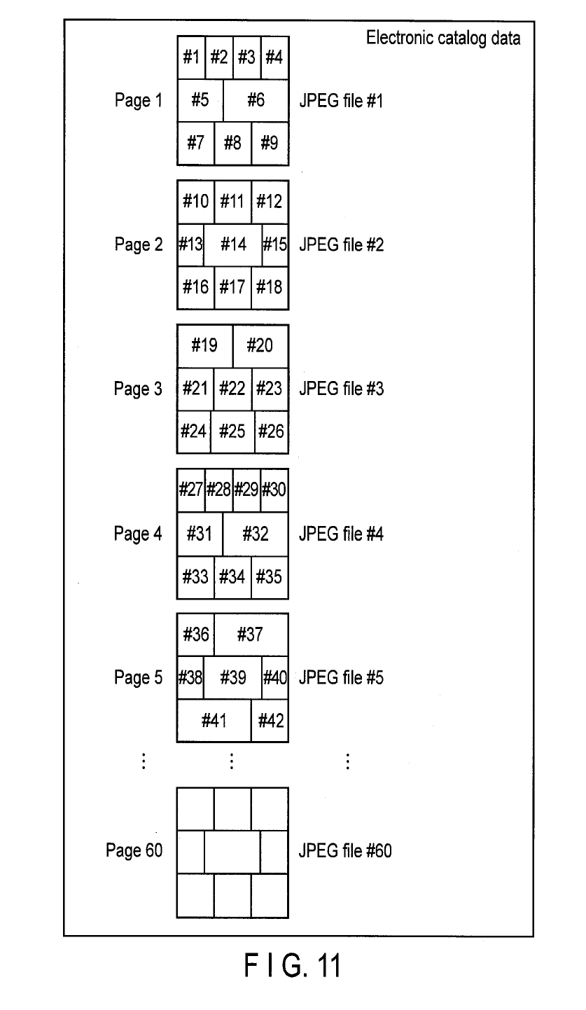

The electronic catalog data (original catalog data) is transmitted, for example, from the online shopping server 5 to the catalog distribution server 2. The electronic catalog data is constituted by a plurality of pages, for example, sixty pages as shown in FIG. 11. Each page includes a plurality of images corresponding to a plurality of products. The data on each page may be JPEG files. Each of the JPEG files is converted to bit map (BMP) data by the JPEG/BMP convertor 401 shown in FIG. 10. The bit map data is transmitted to the noise canceller 402. The noise canceller 402 executes processing for cancelling noise in the bit map data. The noise canceller 402 also subjects the bit map data to processing such as contrast correction and color correction, etc.

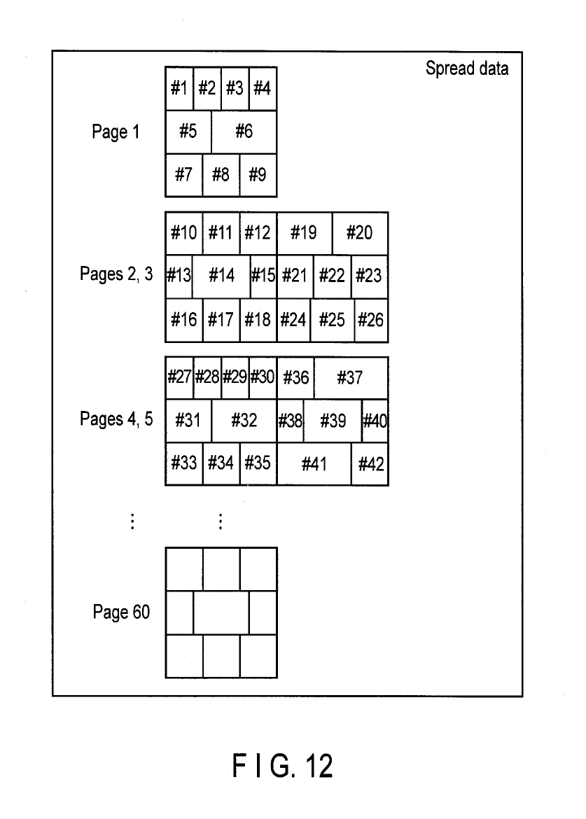

Then, the bit map data is transmitted to the spread image generator 403. The spread image generator 403 generates spread type catalog data as shown in FIG. 12. In the spread type catalog data, for example, page 2 and page 3 in FIG. 11 are integrated and, similarly, page 4 and page 5 in FIG. 11 are also integrated. The spread type catalog data is stored in a database 421.

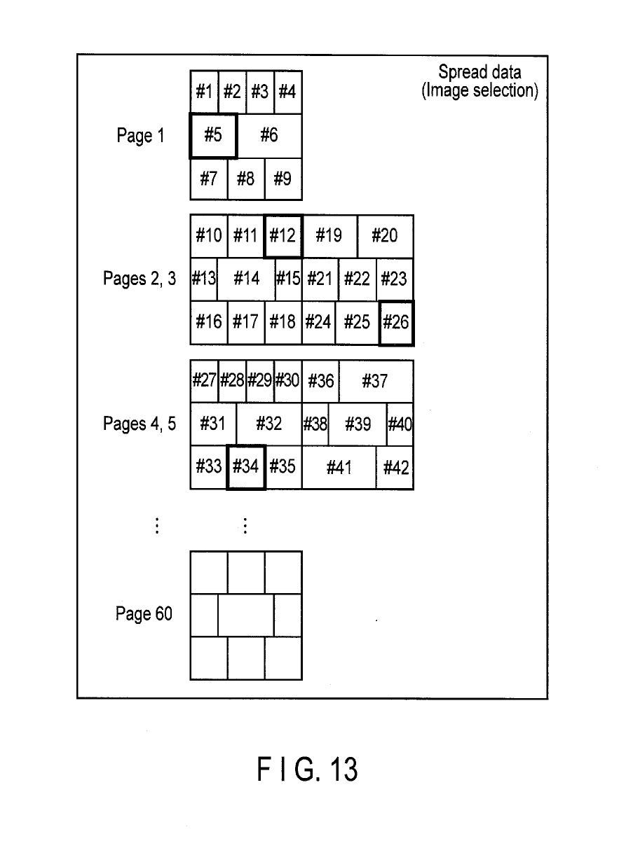

The tool 6A of the operation terminal 6 can display the spread type catalog data stored in the database 421 on an edit screen of the operation terminal 6. The operator can select several image data items from the displayed spread type catalog data. FIG. 13 illustrates the spread type catalog data displayed on the edit screen of the operation terminal 6. In FIG. 13, an image surrounded by a frame of a thick line indicates the image selected by the operator.

The image extractor 404 shown in FIG. 10 extracts a plurality of image data items from the electronic catalog data (i.e., spread type catalog data), as image data to be displayed on the catalog digest data, based on the operator's operations. In other words, each of image data items selected by the operator's selecting operation is extracted from the spread type catalog data. Each of the extracted image data items is transmitted to the scaler 405. The scaler 405 resizes each of the image data items extracted in order to convert each of the image data items extracted to image data of a determined size. The catalog digest data including the plurality of image data items selected is thereby generated. The catalog digest data is stored in a database 422.

In the above descriptions, the catalog digest data is generated by generating the spread type catalog data from the original catalog data and extracting several image data items from the spread type catalog data. However, the catalog digest data may be generated by extracting several image data items from the original catalog data.

The tool 6A of the operation terminal 6 can display the catalog digest data stored in the database 422 on the edit screen of the operation terminal 6. The operator can designate the image effect, sound effect, comments, etc. that should be added to each of image data items in the catalog digest data.

The sound effect ID adder 406 associates the sound effect ID with each of the image data items in the catalog digest data, based on an operator's operation. The effect ID adder 407 associates the effect ID with each of the image data items in the catalog digest data, based on an operator's operation. The comment adder 408 associates the comment with each of the image data items in the catalog digest data, based on an operator's operation.

The image quality enhancer 409 improves image quality for each of the image data items in the catalog digest data (image quality improvement). In the image quality improvement, processing for restoring an image color, image brightness, feeling of image, etc. is executed.

The BMP/JPEG converter 410 converts the bit map (BMP) data format, of each of the image quality-improved image data items, to the JPEG data format. The encoder 411 compression-encodes each of the image data items of the JPEG data format.

Thus, in the present embodiment, the sizzling feeling of products can be emphasized since the image quality enhancement, effect (effect image), and the sound effect such as the cooking sound are added to the image data of each product extracted from the electronic catalog data. As a result, desire to purchase the products can be increased.

In addition, the effect image data and the sound effect data are stored in the client device 1. For this reason, since the effect image data and the sound effect data do not need to be transmitted to the client device 1, increase in the transmission data amount is not caused. Accordingly, even if the bandwidth of the user's communication network environment is narrow, the product images and additional information can be easily provided to the user.

Furthermore, a plurality of product images in the catalog digest data are played automatically and sequentially. Therefore, the user can easily view a plurality of product images in the catalog digest data without manually changing the images to be displayed. Moreover, since the size of each of the product images in the catalog digest data is optimized to the size of the catalog digest screen, each of the product images can be presented to the user with a high visibility.

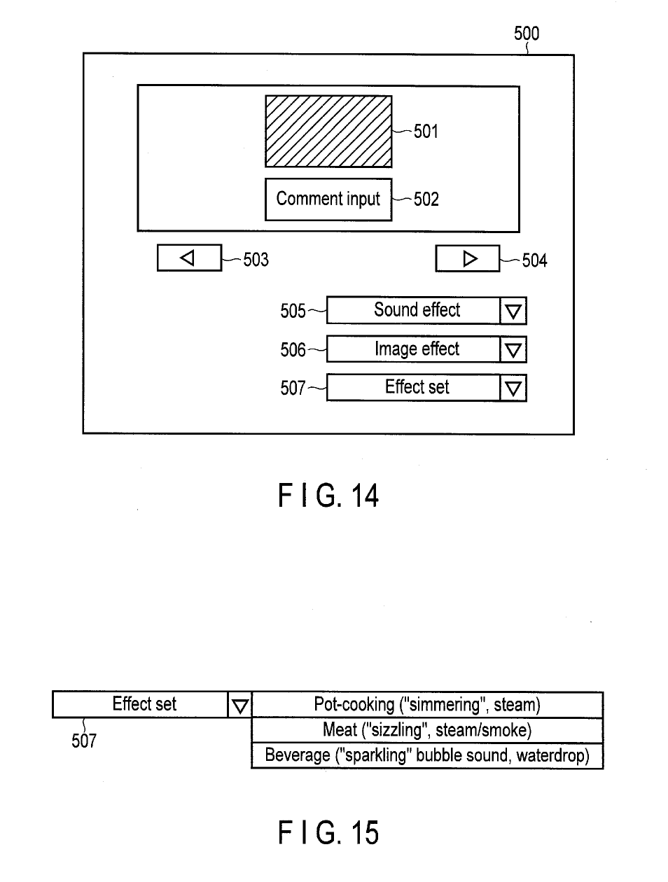

FIG. 14 Illustrates the edit screen displayed on the display of the operation terminal 6.

The edit screen 500 displays an image display region 501, a comment input region 502, a left arrow button 403, a right arrow button 504, a sound effect pull-down menu 505, an image effect pull-down menu 506, and an effect set pull-down menu 507.

The image display region 501 is a region where arbitrary image data in the catalog digest data is displayed. The operator can change the image data to be displayed in the image display region 501 to previous image data or subsequent image data by clicking the left arrow button 503 or the right arrow button 504. The comment input region 502 is a region where a comment to be add to the image data currently displayed in the image display region 501 is input.

The sound effect pull-down menu 505 is a user interface for selecting one of a plurality of sound effects stored in the client device 1. When the sound effect pull-down menu 505 is clicked, a list of available sound effects is displayed. The operator can select the sound effect to be added to the image data currently displayed in the image display region 501 from the list of sound effects.

The image effect pull-down menu 506 is a user interface for selecting one of a plurality of effect images stored in the client device 1. When the image effect pull-down menu 506 is clicked, a list of available effect images is displayed. The operator can select the effect image to be added to the image data currently displayed in the image display region 501 from the list of effect images.

The effect set pull-down menu 507 is a user interface for selecting one of a plurality of effect sets each indicating a combination of the sound effect and the effect image. A plurality of effect sets correspond to food types, respectively. For example, an effect set corresponding to the pot-cooking includes a combination of the “simmering” sound effect and the effect image indicating steam. An effect set corresponding to meat includes a combination of the “sizzling” sound effect and the effect image indicating steam/smoke. An effect set corresponding to the beverage includes a combination of the sound effect of “sparkling” bubble and the effect image indicating water drops. When the effect set pull-down menu 507 is clicked, a list of available effect sets is displayed as shown in FIG. 15. The operator can select the combination of the sound effect and the effect image to be added to the image data currently displayed in the image display region 501 from the list of effect sets.

In the present embodiment, the sound effect ID, the effect ID, and the comment can be associated with each of the image data items, based on the operator's operation executed on the edit screen 500. The operator can therefore easily set additional information that the operator wishes to play together with each of the image data items, in the catalog digest data.

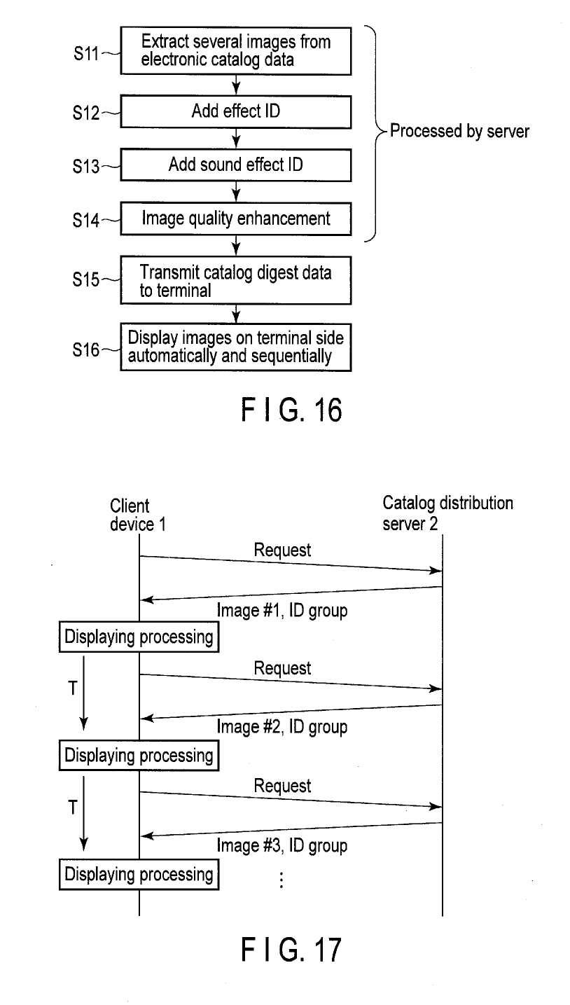

A flowchart of FIG. 16 illustrates procedure of the catalog digest data production process executed by the catalog distribution server 2.

The catalog distribution server 2 extracts the several image data items corresponding to several products from the electronic catalog data in accordance with the operator's operation, and produces the catalog digest data including the several image data items (step S11). The catalog distribution server 2 adds the effect ID and the sound effect ID to each of image data items in the catalog digest data in accordance with the operator's operation, and thereby associates the effect ID and the sound effect ID with each of the image data items (steps S12 and S13). The catalog distribution server 2 executes the image quality enhancement for each of image data items in the catalog digest data (step S14).

The catalog distribution server 2 transmits the catalog digest data to the client device 1 (step S15). In step S15, the catalog distribution server 2 transmits each of image data items in the catalog digest data to the client device 1, together with the effect ID and the sound effect ID associated with the image data, to allow each of image data items in the catalog digest data to be played together with the sound effect and the effect image. The client device 1 displays the plurality of image data items in the catalog digest data, automatically and sequentially (step S16).

FIG. 17 illustrates an example of a catalog digest data transmitting operation executed by the catalog distribution server 2.

The client device 1 first requests the catalog distribution server 2 to transmit the image data of the catalog digest data to the client device 1. The catalog distribution server 2 transmits to the client device 1 the image data #1 in the catalog digest data together with the sound effect ID, the effect ID, the comment, etc. associated with the image data #1. The client device 1 displays the screen shown in FIG. 8A (image data #1, effect image and comment) and plays the sound effect corresponding to the sound effect ID associated with the image data #1.

The client device 1 requests the catalog distribution server 2 to transmit subsequent image data of the catalog digest data while the image data #1, the effect image and the comment are displayed. The catalog distribution server 2 transmits to the client device 1 the image data #2 in the catalog digest data together with the sound effect ID, the effect ID, the comment, etc. associated with the image data #2.

When a time in which the image data #1, the effect image and the comment are displayed reaches a threshold time T (for example, ten seconds), the client device 1 displays the screen shown in FIG. 8B (image data #2, effect image and comment) and plays the sound effect corresponding to the sound effect ID associated with the image data #2.

The client device 1 requests the catalog distribution server 2 to transmit further subsequent image data of the catalog digest data while the image data #2, the effect image and the comment are displayed. The catalog distribution server 2 transmits to the client device 1 the image data #3 in the catalog digest data together with the sound effect ID, the effect ID, the comment, etc. associated with the image data #3.

When a time in which the image data #3, the effect image and the comment are displayed reaches a threshold time T (for example, ten seconds), the client device 1 displays the screen shown in FIG. 8C (image data #3, effect image and comment) and plays the sound effect corresponding to the sound effect ID associated with the image data #3.

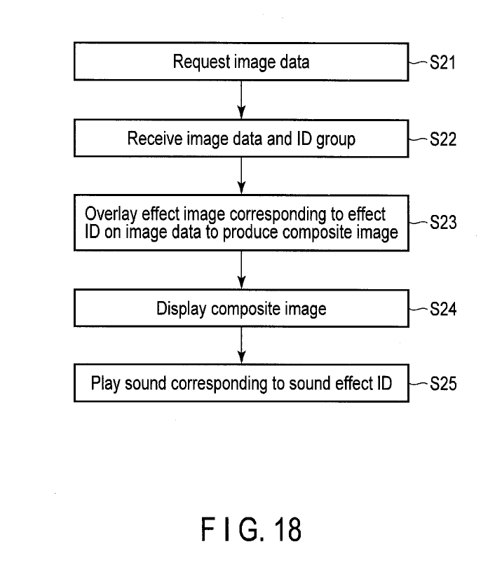

A flowchart of FIG. 18 illustrates procedure of the catalog digest data playing process executed by the client device 1. The playing process corresponding to a certain one of image data items in the catalog digest data will be described here.

The client device 1 requests the catalog distribution server 2 to transmit the image data in the catalog digest data (step S21). The client device 1 receives the product image data, and the sound effect ID and the effect ID associated with the product image data, from the catalog distribution server 2 (step S22). The client device 1 overlays the effect image corresponding to the effect ID on the product image data (step S23) to produce the composite image, and displays the composite image (step S24). Furthermore, the client device 1 plays the sound (sound effect) corresponding to the sound effect ID (step S25).

Incidentally, the above-described functions of the client device 1 may be built in the television receiver 3.

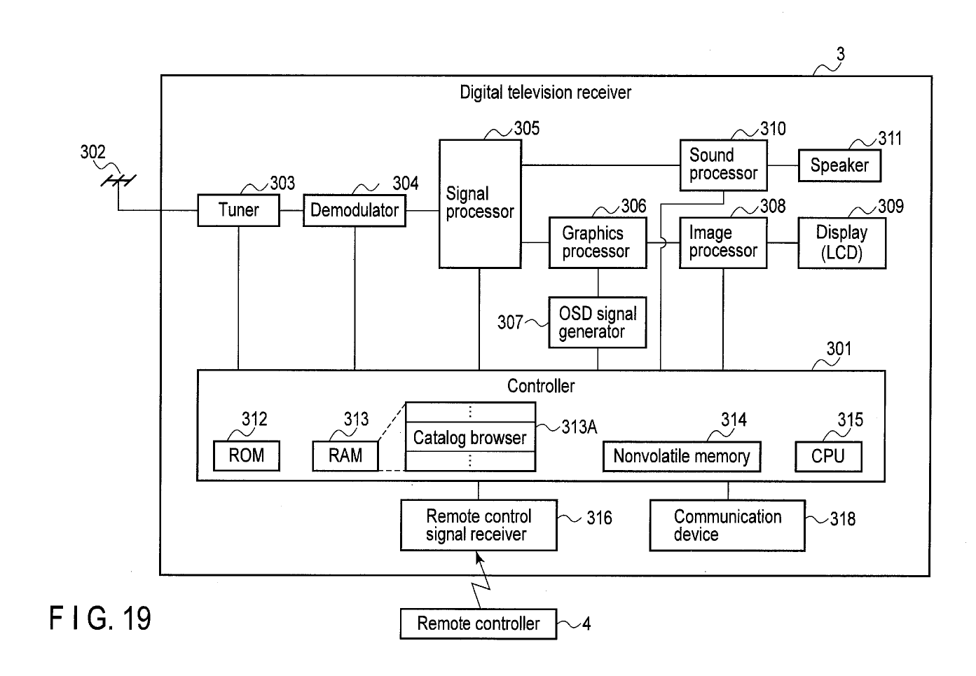

FIG. 19 illustrates an example of a system configuration of the television receiver 3 in which the functions of the client device 1 are built.

The television receiver 3 comprises a controller 301, a tuner 303, a demodulator 304, a signal processor 305, a graphics processor 306, an OSD signal generator 307, an video processor 308, a display (LCD) 309, a sound processor 310, a speaker 311, a remote control signal receiver 316, a communication device 318, etc.

The controller 301 controls operations of the respective components in the digital television receiver 3. The controller 301 comprises a ROM 312, a RAM 313, a nonvolatile memory 314 and a CPU 315. The ROM 312 stores a control program and various application programs executed by the CPU 315. The nonvolatile memory 314 stores various types of setting information and control information. The CPU 315 loads instructions and data necessary for the processing on the RAM 313 and executes the processing.

An antenna 302 for broadcast signal reception receives digital television broadcast signals (for example, a digital terrestrial television broadcasting signal, a digital satellite television broadcasting signal, etc.). The antenna 302 for broadcast signal reception outputs the received digital television broadcasting signal to the tuner 303 via an input terminal. The tuner 303 selects the broadcasting signal of the channel selected by the user from the broadcasting signals. The tuner 303 outputs the selected broadcasting signal to the demodulator 304 (for example, OFDM (Orthogonal Frequency Division Multiplexing) demodulator, PSK (Phase Shift Keying) demodulator, etc.). The demodulator 304 demodulates the broadcasting signal selected by the tuner 303 to generate a digital video signal and a digital sound signal. The demodulator 304 outputs the digital video signal and the digital sound signal to the signal processor 305.

The signal processor 305 subjects the digital video signal and the digital sound signal to predetermined digital signal processing. The signal processor 305 outputs the video signal and the sound signal subjected to the predetermined digital signal processing to the graphics processor 306 and the sound processor 310.

The sound processor 310 converts the digital sound signal to an analog sound signal which can be played at the speaker 311. The sound processor 310 outputs the analog sound signal to the speaker 311. The speaker 311 outputs sound corresponding to the analog sound signal.

The graphics processor 306 superimposes an OSD signal of a menu, etc. generated by the OSD (On Screen Display) signal generator 207 on the digital video signal output from the signal processor 305. The graphics processor 306 outputs the vide signal on which the OSD signal is superimposed, to the video processor 308. In addition, the graphics processor 306 may output either the video signal, which is the output of the signal processor 305, or the OSD signal, which is the output of the OSD signal generator 307.

The video processor 308 executes predetermined processing for the video signal. The video processor 308 converts the digital image signal subjected to a predetermined processing to an analog video signal which can be displayed on the display 309. The video processor 308 outputs the analog video signal to the display 309. The display 309 displays the image corresponding to the analog video signal.

The communication device 318 is a device configured to execute, for example, wireless communication such as 3G mobile communication and wireless LAN, wired communication such as wired LAN, etc.

The remote control signal receiver 316 receives a remote control signal (for example, infrared signal) transmitted by the remote controller 4. The remote control signal receiver 316 outputs the received remote control signal to the controller 301.

In the nonvolatile memory 314, the plurality of sound effect data items and the plurality of effect image data items are stored.

Various application programs are stored in the ROM 312 as described above. The application programs include, for example, a catalog browser 313A. The catalog browser 313A has a functional structure similar to the functional structure of the catalog browser 103B executed on the client device 1. Accordingly, the CPU 315 can execute display control of the catalog digest data (for example, playing the sound effect and playing the effect image) on the television receiver 3 by executing the catalog browser 313A loaded on the RAM 313.

In the present embodiment, as described above, the catalog distribution server 2 sets the sound effect ID for each of the plurality of image data items, based on the operator's operations. The catalog distribution server 2 transmits each of the plurality of image data items together with the sound effect ID associated with the image data, to the terminal (client device 1, etc.), and causes the terminal to play each of the plurality of image data items and sound effect data items corresponding to each of the plurality of image data items. Therefore, the product images and the additional information can be easily provided to the user while suppressing the transmission data amount.

A plurality of sound data items indicating plural types of cooking sounds can be used as the plurality of sound effect data items. The sizzling feeling can be thereby added to the image data corresponding to foods.

Furthermore, the catalog distribution server 2 can execute the processing for associating one of the plurality of effect image data items with each of the plurality of image data items, based on the operator's operations. The products can be thereby presented more attractively to the user.

All the processing steps of the present embodiment can be executed by software. For this reason, the same advantages as those of the present embodiment can be easily implemented by using a computer-readable storage medium which stores a program for executing the steps of each type of the processing, installing the program in a general computer by the storage medium, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a processor to generate content data comprising image data corresponding to products, and to associate a sound effect identifier indicative of sound effect data stored in a memory region in a terminal with the image data in accordance with an operator's operation; and
a transmitter to transmit to the terminal the image data together with the sound effect identifier associated with the image data in order to cause the terminal to play the image data and the sound effect data corresponding to the image data.

2. The apparatus of claim 1, wherein
the products comprise foods, and
the sound effect data comprises sound data for playing plural types of cooking sounds.

3. The apparatus of claim 1, wherein
the processor further associates an effect image identifier indicative of effect image data stored in the memory region of the terminal with the image data in accordance with an operator's operation, and
the transmitter transmits to the terminal the image data together with the sound effect identifier associated with the image data and the effect image identifier associated with the image data in order to causes the terminal to play the image data, the sound effect data corresponding to the image data, and the effect image data corresponding to the image data.

4. The apparatus of claim 1, wherein the processor extracts the image data corresponding to the products from an electronic catalog data in accordance with an operator's operation.

5. The apparatus of claim 1, wherein the processor extracts the image data corresponding to the products from electronic catalog data in accordance with an operator's operation, and subjects the image data extracted to an image quality enhancement process.

6. The apparatus of claim 1, wherein the terminal displays the image data received from the information processing apparatus, and plays the sound effect data designated by the sound effect identifier received from the information processing apparatus while the received image data is displayed.

7. An image data transmission method, comprising:
generating content data including image data corresponding to products;
associating a sound effect identifier indicative of sound effect data stored in a memory region in a terminal with the image data in accordance with an operator's operation; and
transmitting to the terminal the image data together with the sound effect identifier associated with the image data in order to cause the terminal to play the image data and the sound effect data corresponding to the image data.

8. The method of claim 7, wherein
the products comprise foods, and
the sound effect data comprises sound data for playing plural types of cooking sounds.

9. The method of claim 7, further comprising associating an effect image identifier indicative of effect image data stored in the memory region of the terminal with the image data in accordance with an operator's operation,
wherein the transmitting comprises transmitting to the terminal the image data together with the sound effect identifier associated with the image data and the effect image identifier associated with the image data in order to causes the terminal to play the image, the sound effect data corresponding to the image data, and the effect image data corresponding to the image data.

10. A computer-readable, non-transitory storage medium having stored thereon a computer program which is executable by a computer, the computer program controlling the computer to execute functions of:
generating content data including image data corresponding to products;
associating a sound effect identifier indicative of sound effect data stored in a memory region in a terminal with the image data in accordance with an operator's operation; and
transmitting to the terminal the image data together with the sound effect identifier associated with the image data in order to cause the terminal to play the image data and the sound effect data corresponding to the image data.

11. The storage medium of claim 10, wherein
the products comprise foods, and
the sound effect data comprises sound data for playing plural types of cooking sounds.

12. The storage medium of claim 10, wherein
the computer program further controls the computer to execute a function of associating an effect image identifier indicative of effect image data stored in the memory region of the terminal with the image data in accordance with an operator's operation,
wherein the transmitting comprises transmitting to the terminal the image data together with the sound effect identifier associated with the image data and the effect image identifier associated with the image data in order to causes the terminal to play the image data, the sound effect data corresponding to the image data, and the effect image data corresponding to the image data.
